(19) United States
(12) Patent Application Publication
(10) Pub. No.: US 2026/0254614 A1
(43) Pub. Date: Aug. 27, 2026

(54) TECHNIQUES FOR IMPROVED PROOF OF REVIEW VALIDATION THROUGH EMBEDDED, DEPENDENT VALIDATION CHECKS

(71) Applicant: Optum Services (Ireland) Limited, Dublin 1 (IE)

(72) Inventors: Jitesh K. Singh, Dublin (IE); Seamus S. Brady, Dublin 14 (IE); Sukriti Shukla, Ulster (IE); Heather J. Slevin-Dower, Co. Tipperary (IE)

(21) Appl. No.: 19/061,562

(22) Filed: Feb. 24, 2025

(51) Int. Cl. H04L 9/08; H04L 9/06

(52) U.S. Cl. CPC H04L 9/0822; H04L 9/0656

(57) ABSTRACT

Techniques for improved proof of review validation may comprise determining locations within a file to embed validation checks and may embed a first validation check at a first location and a second validation check at a second location. The second validation check may have an associated response that is dependent on the first validation check's associated response. The validation algorithm may reveal the second validation check responsive to receiving the first validation check's associated response. The techniques may further comprise preventing release of the file until the associated response to the second validation check is received. These techniques enhance the effectiveness of proof of review systems at least by preventing users from circumventing or avoiding the validation checks in a manner that ensures reviewer engagement with the file data/content.

### TECHNICAL FIELD

The present disclosure generally relates to embedded, dependent validation checks that improve proof of review effectiveness. The techniques described herein comprise embedding, managing, and validating chains of embedded, dependent validation checks using unique identifiers, check reveal sequencing, and/or encryption schemes.

### BACKGROUND

Techniques for validating data within files through a proof of review process suffer from notable drawbacks. Namely, existing techniques are generally incapable of accurately validating that content within a file has been reviewed and lack safeguards to effectively prevent the inadvertent release of documents that have not been adequately vetted.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1 depicts an example computing system in which various embodiments of the present disclosure may be implemented.

FIG. 2 depicts an example validation check computing environment workflow, in accordance with various embodiments described herein.

FIG. 3 depicts an example validation check computer-implemented process, in accordance with various embodiments described herein.

FIG. 4 depicts an example validation check embedding and dependent reveal computer-implemented process, in accordance with various embodiments described herein.

FIG. 5 depicts an example validation check encryption computer-implemented process, in accordance with various embodiments described herein.

FIG. 6 depicts an example validation check circumvention prevention computer-implemented process, in accordance with various embodiments described herein.

FIG. 7 depicts a flow diagram representing an example computer-implemented method, in accordance with various embodiments described herein.

### DETAILED DESCRIPTION

Broadly speaking, the proof of review validation techniques of the present disclosure accurately validate that content within a file has been reviewed through multiple safeguard measures. More specifically, the techniques of the present disclosure may execute a validation algorithm configured to determine locations within a file at which to embed validation checks (“embedding locations”), embed the validation checks within the file at those locations, and sequentially reveal embedded validation checks as prior validation checks are correctly answered, as part of a dependent chain of such checks. In some examples, the embedding locations may be proximate to a particular type, amount, or predetermined key content within the file. The techniques of the present disclosure may also prevent release (e.g., further distribution to other users) of the file until up to each validation check included as part of the dependent chain is correctly answered in sequence. For example, a release may comprise changing permissions on the file such that a new set of users is able to access the file; transmitting the file from a first computing device, cloud container, cloud region, or the like to another or between computing environments associated with different entities; etc. The techniques of the present disclosure enhance the effectiveness of existing proof of review techniques at least by (1) enforcing association of the validation checks with the data to be validated (e.g., via embedding directly in the file), (2) delaying visibility and completion of some validation checks until prior validation checks are correctly answered/resolved, and (3) preventing release of the file until all validation checks are correctly answered in the intended sequence.

Existing proof of review techniques often fall short in ensuring that reviewers genuinely engage with the data they are supposed to review. Many existing techniques enable reviewers to bypass the data intended for review entirely, focusing solely on completing the validation process. For instance, systems that employ separate validation processes, where the validation checks are distinct and separated (e.g., in terms of location) from the file data, often allow reviewers to complete the validation without engaging with the data at all. As an example, a validation process requiring a user to spend a certain amount of time on a page without verifying the user's actions during that time enables that user to simply wait for the required duration on a page without reviewing the material and then proceed to the validation check. Similarly, requiring a user to scroll through a file without verifying that the text was read or understood allows users to fulfill the technical requirements of the review without meaningful engagement. This disconnection between the validation checks and the file data thereby undermines the purpose of ensuring thorough review.

Moreover, regardless of the placement of such validation checks, existing systems typically display or otherwise make these validation checks accessible to the reviewer immediately upon opening the file. This approach allows reviewers to complete the validation checks immediately by simply identifying their position within the file, again without reviewing the data. Systems that display all validation checks simultaneously or rely on a single simplistic validation check at the end of the review process are particularly prone to this issue. Reviewers can see what is required of them from the outset and may complete these checks without ever viewing or otherwise interacting with the data intended for review. For example, systems that use generic checks, such as standard Completely Automated Public Turing tests to tell Computers and Humans Apart (CAPTCHAs) or unrelated, trivial quizzes, are typically visible within files intended for review when the file is opened/accessed. As a result, a reviewer can complete these checks without ever viewing the data intended for review, despite their potential positioning near the relevant data. This issue is exacerbated by predictable patterns in validation checks or the availability of answers on external resources, which further enables users to quickly bypass genuine engagement with the file data.

In contrast, the techniques of the present disclosure address these issues experienced by existing techniques. By executing a validation algorithm to (1) determine specific locations within the file to embed validation checks and (2) embed these checks in a manner that makes them sequentially accessible only after prior checks are correctly answered, the present techniques ensure that reviewers genuinely engage with the file data in a particular sequence to perform a thorough review. Namely, unlike existing techniques utilizing separate validation processes, the present techniques embed validation checks directly within the file data, ensuring that reviewers cannot bypass the intended data review and proceed directly to the validation checks. Additionally, the present techniques further ensure users cannot bypass the file data review by making the visibility and completion of some validation checks dependent on the correct resolution of prior checks. This approach ensures that even if checks are proximate to the content, they cannot be easily bypassed or ignored, requiring genuine engagement with the content before proceeding. Thus, the present techniques directly address the issues of bypassing data review and immediately viewable/accessible checks, as the dependent chain of validation checks necessitates interaction with the content at specific locations within the file and in a specific sequence, thereby preventing users from skipping the review entirely and/or immediately identifying and completing the validation checks upon opening/accessing the file.

Moreover, by preventing file release until all validation checks are correctly answered/resolved in the correct sequence, the present techniques further force users to complete the entire review in sequence without simply circumventing or otherwise avoiding some validation checks. For example, in addition to the conditional reveal of validation checks based on successful responses to prior validation checks, the present techniques may prevent release of the file by setting a digital lock or flag on the file that is only removed once the review process is successfully completed, adding a conditional release flag to the file's metadata that only changes to indicate the file is ready for release (e.g., from “review_pending” to “review_completed”) once all validation checks are correctly resolved, queueing the file for transmission but only executing the transfer once it verifies that all validation checks have been correctly answered, storing the file in a restricted access area that only becomes accessible once the review process is completed, generating a digital certificate or token upon successful completion of the review process that would be required for any further actions with the file (e.g., sharing, publishing, or archiving), generating/providing notifications or alerts to inform the reviewer of the specific validation checks that are unanswered or incorrectly answered with instructions on how to access and resolve them, and/or any combinations thereof.

In certain embodiments, the present techniques improve the robustness of the proof of review process by encrypting the validation checks and/or their associated responses. The present techniques may include creating a response key that stores up to each of the encrypted associated responses and/or the validation checks. Further, the present techniques may include preventing release of the file until the encrypted responses are received in the appropriate sequence and/or detecting that a copy action has occurred in association with a validation check and may automatically insert a character into the copied text, a response to the validation check, or some other portion of the file. These actions improve the integrity and security of the review process, as compared to many existing techniques.

For example, encrypting the validation check associated responses using a unique encryption scheme, where the encryption of the second response is dependent on the encryption of the first, creates a secure and tamper-evident chain of validation checks. Additionally or alternatively, by creating and storing a response key that includes both the encrypted responses and an indication of the chain of dependent, encrypted validation checks, the system establishes a secure and verifiable path through the review process. This allows for the verification of each step in the review process, ensuring that reviewers have completed each validation check in the correct order before proceeding. This ensures that only responses that have been properly reviewed and validated can proceed through the chain, enhancing the security and reliability of the review process. Further, the ability to detect copy actions and automatically insert characters to prevent matching of copied responses addresses a common method of circumventing review processes in existing techniques. This technique ensures that simply copying and pasting responses will not allow a reviewer to bypass the review process, as the altered copied text will not match the encrypted response in the response key.

Overall, these concepts enhance the security and integrity of the proof of review process by ensuring that each validation check is completed in a secure and verifiable manner. By leveraging encryption and requiring sequential completion of dependent validation checks, the system minimizes the risk of unauthorized access or manipulation, ensuring that the review process is both thorough and reliable.

These techniques thus contribute an improvement to the field of proof of review by addressing and overcoming the limitations of existing proof of review techniques. By embedding validation checks directly within the file and making subsequent checks dependent on the correct resolution of prior ones, the disclosed methods ensure that reviewers genuinely engage with the content in a specific sequence. This approach directly counters the prevalent issue of reviewers bypassing the intended review process, thereby enhancing the effectiveness and reliability of proof of review systems. The sequential and dependent nature of the validation checks, coupled with the prevention of file release until all checks are correctly answered, ensures a thorough and genuine review process, representing a significant advancement in the field.

The described techniques also represent a practical application of the concepts embodied therein at least by providing a concrete and specific method to secure and validate the review process. The implementation of a validation algorithm that determines embedding locations for validation checks, embeds these checks within the file, and controls their visibility based on prior responses, offers a practical solution to the challenges faced by existing proof of review systems. Additionally, the incorporation of encryption to secure the validation checks and responses further enhances the integrity and security of the review process. These measures not only address the practical challenges of ensuring genuine engagement with review content but also improve the overall security and reliability of the review process, as compared to existing techniques. In some examples, the techniques discussed herein include some hardening to circumventing the validation checks using generative machine-learned models, such as large language models (LLMs).

Still further, the present disclosure includes specific features other than what is well-understood, routine, conventional activity in the field, or adding unconventional steps that demonstrate, in various embodiments, particular useful applications, e.g., executing a validation algorithm that causes the one or more processors to perform operations comprising: determining a first location and a second location within the file to embed validation checks having an associated response, embedding a first validation check at the first location and a second validation check at the second location, wherein the second validation check has a second associated response that is dependent on a first associated response to the first validation check, and responsive to receiving the first associated response to the first validation check, revealing the second validation check within the file, and/or preventing release of the file until the second associated response to the second validation check is received, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the health care context, the techniques described herein may be readily applied in any suitable field for any suitable purpose.

### Example Computing System

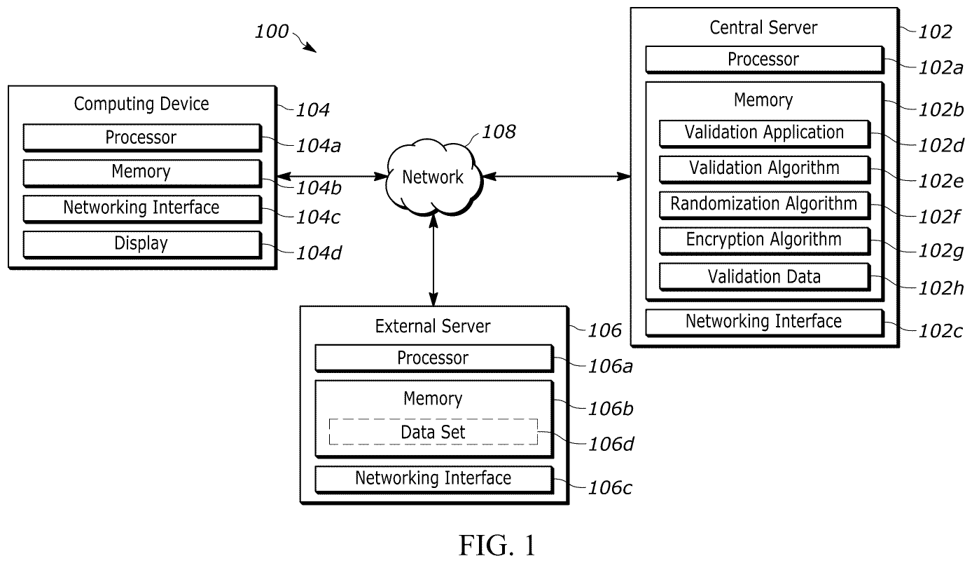

FIG. 1 depicts an example computing system 100 in which various embodiments of the present disclosure may be implemented. Depending on the embodiment, the example computing system 100 may determine validation check embedding locations, embed the validation checks within a file at the determined locations, check received responses with known associated responses of the validation checks, reveal validation checks responsive to receiving associated (e.g., correct) responses, releasing/preventing release of files based on the responses received to the validation checks, encrypting validation checks or their responses, and/or perform actions associated with any related values or combinations thereof. Of course, it should be appreciated that, while the various components of the example computing system 100 (e.g., central server 102, computing device 104, external server 106) are illustrated in FIG. 1 as single components, the example computing system 100 may include multiple (e.g., dozens, hundreds, thousands) of computing devices 104 and external servers 106 that are simultaneously connected to the network 108 at any given time.

Generally, the example computing system 100 includes a central server 102, a computing device 104, and an external server 106. Each of the central server 102, the computing device 104, and the external server 106 may communicate with the other devices (e.g., transmit data, instructions, etc.) across the network 108. As an example, the external server 106 may belong to an entity that provides healthcare claim appeals letter drafting services and the computing device 104 may belong to a patient associated with the healthcare claim appeal or a reviewer of the healthcare claim appeals letter. In this example, the external server 106 may transmit data (e.g., validation data including a file, such as a letter including text data) to the central server 102, and the server 102 may execute a validation application 102d to embed and manage validation checks within the file to facilitate the proof of review process. The central server 102 may make the file with the embedded validation checks accessible to a reviewer via the computing device 104, so the reviewer may review the embedded file to review the data contained therein, complete the validation checks in the intended sequence (e.g., providing the correct associated response to the validation checks), and/or any other suitable actions or combinations thereof.

More specifically, the central server 102 may include one or more processors 102a, a memory 102b, and a networking interface 102c. The memory 102b may store executable instructions that are configured to, when executed by the one or more processors 102a, cause the one or more processors 102a to analyze data (e.g., data set 106d) received at the central server 102 and output various values (e.g., a validated file). The validation application 102d, the validation algorithm 102e, the randomization algorithm 102f, the encryption algorithm 102g, and the validation data 102h may all comprise such executable instructions, as well as other data. The memory 102b may additionally or alternatively store additional data and/or databases. It should be appreciated that the central server 102 can include one or multiple computing devices that are co-located or distributed.

The central server 102 may receive a file including data for validation from the external server 106 and/or the computing device 104 connected to the server 102 through a network 108 and process the file in accordance with one or more sets of instructions stored in a memory 102b to perform any of the actions and/or output any of the values described herein. The central server 102 may execute the validation application 102d, which in turn, may access and apply one or more of the validation algorithm 102e, the randomization algorithm 102f, the encryption algorithm 102g, and/or the validation data 102h to the received file.

As mentioned, the received file may be a text document (e.g., healthcare claim appeals letter, articles, reports, research papers, legal documents) but may be or include any suitable types of files such as a digital document, dataset, and/or any form of content that requires review and validation before it the validation application 102d may determine the file to be verified, approved, and/or release the file for further use or distribution. For example, the file may include datasets that need to be reviewed for accuracy, completeness, and adherence to data protection standards (e.g., for scientific research or data analytics). As another example, the file may include source code or executable programs that need to be reviewed for security vulnerabilities, coding standards compliance, or functionality before being integrated into a larger codebase or released (e.g., for software development processes). In another example, the file may include multimedia content/data, such as images, videos, and/or audio files that require validation for copyright compliance, content appropriateness, or quality assurance purposes.

The validation application 102d may generally orchestrate the embedding of validation checks within a file, manage the sequential revealing of these checks as prior checks are correctly answered, and ensure the file is not released until all checks are correctly resolved. Upon receiving a new file, the validation application 102d may execute the validation algorithm 102e to determine embedding locations within the file for validation checks. As further described herein, each validation check may generally comprise executable code that is embedded into a file and thereby integrated into the file's data or content (e.g., making them an intrinsic part of the file) and/or code that is inserted directly into a file (e.g., via additional spaces in the file text). The validation checks may specifically comprise text-based questions, interactive elements, executable code, encryption-based challenges, and/or other suitable questions, puzzles, etc. that prompt the reviewer for input or actions that demonstrate acknowledgment (e.g., review) of the content proximate to the validation check.

The validation application 102d may also utilize unique identifiers, check reveal sequencing/dependencies, and/or encryption schemes as part of generating and/or embedding the validation checks within a file. For example, and as described herein, the application 102d may manage and sequentially reveal (e.g., through visible/non-visible states) embedded validation checks, dependent on the completion of prior checks, and the checks may be designed for user interaction directly within the file's content. This approach ensures that reviewers engage with the file's content in a specific sequence, enhancing the thoroughness of the review process.

As part of the embedding location determination process, and in certain embodiments, the application 120d may execute the randomization algorithm 102f to determine these embedding locations in a random or pseudo-random manner, ensuring that the validation process is secure and unpredictable to unauthorized users. The validation checks are then embedded at these locations, and less than all validation checks are made accessible to the reviewer upon viewing/accessing the file for data validation. Upon receipt of a successful (e.g., correct) response to a visible validation check, the application 102d may cause a subsequent validation check to be visible or otherwise accessible to the reviewer, and this process may continue until the reviewer has successfully responded to each validation check in the sequence enforced by the sequential revealing performed by the application 102d. In this manner, the validation application 102d creates a chain of dependent validation checks, wherein the response for up to each validation check (e.g., after the initial check) depends on the answer to a prior validation check and up to each validation check is only visible/accessible to the reviewer once the prior validation check is successfully completed.

If a reviewer attempts to release the file without correctly answering all validation checks in the correct sequence, the validation algorithm 102e may cause the application 102d to prevent the release of the file and may generate an output indicating the location within the file requiring additional review. This ensures that the file is thoroughly reviewed before it is distributed further, such as to a patient expecting accurate information in their appeals letter. Once all validation checks are correctly answered, the validation algorithm 102e may instruct the validation application 102d to remove all validation checks from the file, allowing for its release. This process ensures that the file is only released once it has been fully validated.

In certain embodiments, the validation application 102d may also utilize the encryption algorithm 102g to further improve the effectiveness of the proof of review process. The encryption algorithm 102g may generally cause the application 102d to encrypt the file or any portion of the file, the validation checks, and/or the associated responses to further secure the validation process against the reviewer using impermissible resources (e.g., external large language models (LLMs) or answer databases) to circumvent the validation process.

The encryption algorithm 102g may utilize any suitable encryption scheme(s), such as symmetric encryption (e.g., Advanced Encryption Standard (AES)) using the same key for both encryption and decryption, asymmetric or public-key encryption (e.g., Rivest-Shamir-Adleman (RSA)) using a public key for encryption and a private key for decryption, homomorphic encryption allowing computations to be carried out on ciphertext and generating an encrypted result that, when decrypted, matches the result of operations performed on the plaintext, and/or format-preserving encryption (FPE) to encrypt the file data in such a way that the output (e.g., the encrypted data) is in the same format as the input (e.g., the plaintext data). Additionally, or alternatively, the encryption algorithm 102g may utilize hash functions (e.g., Secure Hash Algorithm 256-bit (SHA-256)) to transform the validation checks and/or their associated responses into fixed-size strings of characters unique to the original check/response and thereby ensure that even if an external resource provides an answer, without the exact phrasing or context used in the validation check, the hashed value will not match, thus securing the process against circumvention. Further, the encryption algorithm 102g may leverage zero-knowledge proofs that force a reviewer to indicate that a statement is true without revealing any information beyond the validity of the statement itself, such as by indicating the correct response to a validation check without revealing the response itself, thereby securing the process against external assistance.

In some embodiments, the validation application 102d may utilize the and/or the randomization algorithm 102f to further improve the effectiveness of the proof of review process. The randomization algorithm 102f may generally be configured to cause the application 102d to randomly or pseudo-randomly determine embedding locations for validation checks and unique identifiers for set of tags delineating where the validation checks are embedded in the file, and to assign the unique identifiers to the sets of tags. In this manner, the randomization algorithm 102f enhances the security and unpredictability of the validation checks embedded within a file.

More specifically, the randomization algorithm 102f may utilize a random or pseudo-random algorithm to determine the embedding locations within the file where the validation checks will be embedded and thereby ensure that the placement of validation checks is unpredictable, making it difficult for reviewers to bypass the intended review process by memorizing the locations of these checks or using automated external resources to find answers that key in on known locations of checks. For example, if the file is distributed to multiple reviewers, the randomized embedding location determination/assignment likely results in validation checks being placed in different locations, thereby requiring genuine engagement with the content/data to locate and respond to each validation check.

Further, the randomization algorithm 102f may utilize another random or pseudo-random algorithm to generate the unique identifiers for sets of tags that delineate where the validation checks are embedded within the file. These unique identifiers enable the validation application 102d to precisely tag the locations within the file where the validation checks are embedded, facilitating the dynamic revelation of validation checks as prior checks are correctly answered, and add an additional layer of security by making it harder for unauthorized parties to tamper with or remove the validation checks, as the identifiers can be used to verify the integrity of the embedded checks. Moreover, the application 102d may also leverage the unique identifiers for tracking responses and analyzing engagement with the validation checks, enabling the application 102d to gather insights into how reviewers interact with the content and the checks.

As an example, when a new file is received at the central server 102, the validation algorithm 102e may instruct the validation application 102d to embed a series of validation checks within the file. The randomization algorithm 102f may cause the application 102d to determine the embedding locations for these checks, and to potentially assign unique identifiers to each validation check for tracking purposes. The encryption algorithm 102g may cause the application 102d to encrypt the associated responses to these validation checks, creating a chain of dependent, encrypted validation checks.

Additionally, the validation application 102d may execute the encryption algorithm 102g to detect any copy actions associated with the validation checks. If such an action is detected, the algorithm 102g may cause the application 102d to automatically insert a character into the copied text or the response to prevent an encrypted version of the response from matching the encrypted associated response in the response key. This feature adds an additional layer of security to the validation process, preventing unauthorized accessing of resources to circumvent the validation process or distribute the file or its contents.

More generally, the computing device 104 may be or include any one or more devices that is associated with (e.g., owned and/or operated by) one or more entities (e.g., a file reviewer) that may provide data (e.g., validation data) that is transmitted to and/or is otherwise accessible by the central server 102 and/or the external server 106 through the network 108. In certain embodiments, the validation data transmitted to and/or otherwise accessible by the central server 102 and/or the external server 106 may be or include a set of input character data associated with a proof of review process facilitated by the computing device 104 to be evaluated by the central server 102 and/or the external server 106. In some embodiments, the computing device 104 is a server or collection of servers hosting the validation data or a portion thereof, e.g., since the validation data may comprise validation data of multiple users received from different computing devices. However, in certain embodiments, the computing device 104 is a personal computing device of that entity/user, such as a smartphone, a tablet, smart glasses, or any other suitable device or combination of devices (e.g., a smart watch plus a smartphone) with wireless communication capability. In the embodiment of FIG. 1, the computing device 104 includes a processor 104a, a memory 104b, a networking interface 104c, and a display 104d.

The computing device 104 may be communicatively coupled to the central server 102 and/or the external server 106. For example, the computing device 104, the central server 102, and/or the external server 106 may communicate via USB, Bluetooth, Wi-Fi Direct, Near Field Communication (NFC), a private or public network (e.g., via an Internet protocol, such as IPv4, via a virtual private network (VPN)), etc. For example, the central server 102 may transmit a file including embedded, dependent validation checks, and/or any other data to the computing device 104 via the networking interface 102c, which the computing device 104 may receive via the networking interface 104c.

The external server 106 may be or include computing servers and/or combinations of multiple servers storing data that may be accessed/retrieved by the central server 102 and/or the computing device 104. In certain embodiments, the external server 106 receives data from the central server 102 and/or the computing device 104 and retrieves/accesses information stored in memory 106b for transmission back to the central server 102 and/or the computing device 104. The external server 106 may include a processor 106a, a memory 106b, and a networking interface 106c. It should be appreciated that the external server 106 can include one or multiple computing devices that are co-located or distributed.

Further, in certain embodiments, the external server 106 may include a data set 106d including data from one or both of the computing device 104 and/or the central server 102. In one such example, the external server 106 may be a server located in and/or otherwise associated with an entity that generates healthcare claims appeals letters, and the data set 106d includes generated healthcare claims appeals letters and/or the like in memory 106b. As another example, the external server 106 may serve as a database for some/all of the validation data 102h. In some embodiments, the example computing system 100 does not include the external server 106.

Each of the processors 102a, 104a, 106a may include any suitable number of processors and/or processor types. For example, the processors 102a, 104a, 106a may each include one or more CPUs and one or more graphics processing units (GPUs). Generally, each of the processors 102a, 104a, 106a may be configured to execute software instructions stored in each of the corresponding memories 102b, 104b, 106b. The memories 102b, 104b, 106b may each include one or more persistent memories (e.g., a hard drive and/or solid-state memory) and may store one or more applications, modules, and/or models, such as the interaction application 102d.

The networking interface 102c may enable the central server 102 to communicate with the computing device 104, the external server 106, and/or any other suitable devices or combinations thereof. More specifically, the networking interface 102c may enable the central server 102 to communicate with each component of the example computing system 100 across the network 108 through their respective networking interfaces 104c, 106c. The networking interfaces 102c, 104c, 106c may support one or more of the communication/network protocols implemented by the network 108. The networking interface 102c may enable the central server 102 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

Moreover, the network 108 may be a single communication network, or may include multiple communication networks of one or more types (e.g., one or more wired and/or PANs or LANs, and/or one or more WANs such as the Internet). In some embodiments, the network 108 includes multiple, entirely distinct networks (e.g., one or more networks for communications between central server 102 and computing device 104, and a separate, Bluetooth or wireless LAN (WLAN) network for communications between central server 102 and computing device 104, and so on).

It will be understood that the above disclosure is one example and does not necessarily describe every possible embodiment. As such, it will be further understood that alternate embodiments may include fewer, alternate, and/or additional steps or elements.

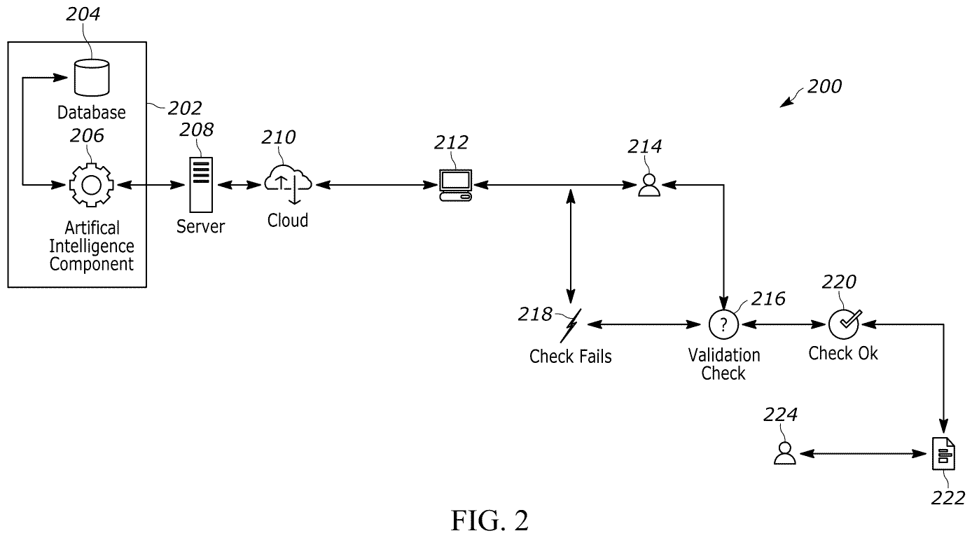

FIG. 2 depicts an example validation check computing environment workflow 200, in accordance with various embodiments described herein. Generally, the example validation check computing environment workflow 200 includes a file generation system 202 configured to generate and transmit files that include data to be validated. For example, the file generation system 202 may generate healthcare claims appeals letters and may transmit the letters to the reviewer's application 212 for review and validation.

The example validation check computing environment workflow 200 includes the file generation system 202 generating a file with data for validation, wherein the system 202 includes an artificial intelligence component 206 that may access and/or otherwise utilize data stored in a database 204 to generate a file with data to be validated. This system 202 may transmit this generated file to a server 208, which may be connected to and/or included as part of a cloud-based network 210. The server 208 may be the central server 102 of FIG. 1, which may execute the validation application 102d to embed validation checks in the file prior to sending the file to the reviewer's application 212. In certain embodiments, the reviewer's application 212 may transmit data representing the reviewer's interactions with the validation checks to the cloud-based network 210 and/or directly to the server 208 to continue the proof of review process by, e.g., validating responses provided to validation checks as correct, revealing subsequent validation checks, determining that all validation checks have been completed in the correct sequence, removing the validation checks from the file, and/or releasing or preventing release of the file.

As the reviewer 214 performs their review of the file, the reviewer 214 may encounter a validation check 216 which forces the reviewer 214 to provide a response to the validation check 216. If the reviewer 214 provides an incorrect response to the validation check 216, the application 212 or the server 208 may determine that the validation check 216 has failed 218, such that the reviewer 214 is forced to re-attempt the validation check 216. The application 212 and/or the server 208 may make this determination and provide the reviewer 214 with an alert or other indication that their response to the validation check 216 was incorrect or insufficient. However, if the reviewer 214 provides the accurate/correct response to the validation check 216, the application 212 and/or the server 208 may determine that the validation check 216 is passed 220, and the application 212 and/or server 208 may reveal a subsequent validation check within the file for the reviewer's 214 analysis. Once the reviewer 214 has correctly responded to each of the validation checks 216 embedded in the file, the application 212 and/or the server 208 may determine that the file 222 is fully validated, remove each of the validation checks (and associated responses) from the file 222, and release the file 222 for distribution to other reviewers and/or the intended end user 224 (e.g., a patient).

As an example, a first validation check may present an arithmetic operation, such as “What is the sum of 14 and 29?” The reviewer may calculate the sum (43) and submit this as their response. The application 212 and/or the server 208 may compare the submitted response to the correct response, and if the responses match, indicating that the reviewer has correctly calculated the sum, the application 21 and/or the server 208 may reveal the next validation check within the file. The next validation check may ask the reviewer to calculate a percentage, such as “If 200 out of 400 surveyed customers are satisfied with a service, what percentage of customers are satisfied?” The reviewer may calculate the percentage (50%) and submit this answer, and if the application 212 and/or the server 208 determines the submitted response matched the correct response, the application 212 and/or the server 208 may reveal yet another validation check within the file. When the reviewer 214 has successfully answered each of the validation checks, the application 212 and/or the server 208 may remove the validation checks and their associated responses from the file before releasing the file. Of course, it should be appreciated that the validation checks described herein may be or include any suitable types of checks, such as mathematical equations, counting elements, timeline events, logic puzzles, pattern recognition, and/or any other checks or combinations thereof.

### Example User Interaction Classification Computer-Implemented Processes

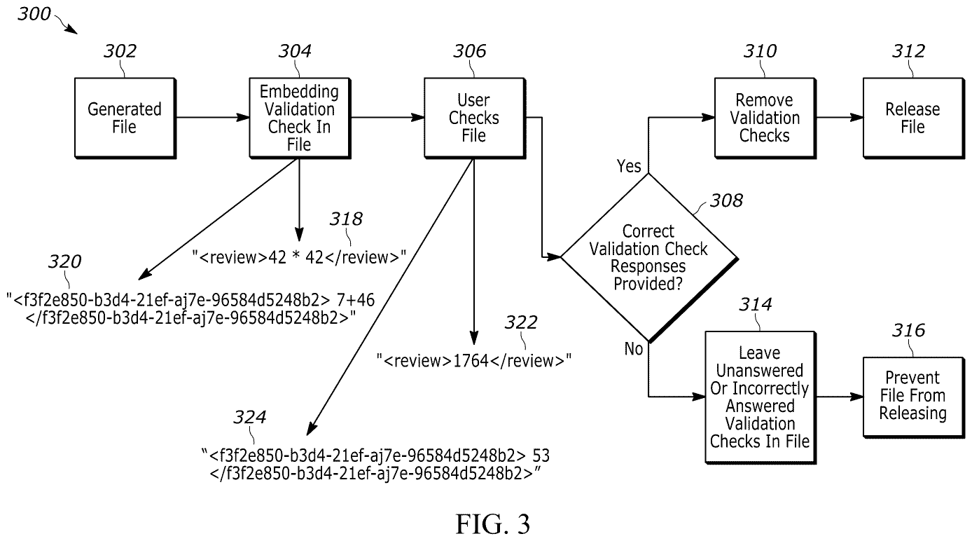

FIG. 3 depicts an example validation check computer-implemented process 300, in accordance with various embodiments described herein. The example validation check computer-implemented process 300 generally indicates several actions performed by a validation application (e.g., validation application 102d) to embed and manage validation checks as part of a proof of review process associated with a generated file 302. For example, the generated file 302 may be a claims appeals letter that is generated by an AI system (e.g., system 202).

At block 304, the application may determine embedding locations and embed validation checks directly within the content of the generated file 302. Each validation check may appear similar to the first validation check 318 and/or the second validation check 320 illustrated in FIG. 3. Each validation check 318, 320 may include a set of identity tags (e.g., “<review” and “</review>”), between which, the specific question (e.g., “42*42”) is positioned. Thus, when preparing the document for review, the application may position the validation check into the generated file 302 at the predetermined location marked by the set of identity tags “<review>” and “</review>”. In certain embodiments, the application may utilize unique identifiers as the identity tags, such as the universally unique identifiers (UUIDs) in the validation check 320 (e.g., “<f3f2e850-b3d4-21ef-aj7e-96584d5248b2>” and “</f3f2e850-b3d4-21ef-aj7e-96584d5248b2>”). These identity tags may generally guide the reviewer to the location of the validation check within the document, ensuring that the reviewer does not miss the check as they engage with the generated file 302 data.

In particular, the application may utilize random or pseudo-random algorithms for both determining the embedding locations of validation checks and assigning unique identifiers to serve as the tags for validation checks present at these embedding locations. As an example, the application may utilize linear congruential generators (LCGs), the Mersenne Twister pseudo-random number generator, a cryptographically secure pseudo-random number generator (CSPRNG), hash functions, the Fisher-Yates Shuffle algorithm, noise functions, and/or any other suitable random/pseudo-random functions or combinations thereof to generate the embedding locations and/or the unique identifiers. This random/pseudo-random approach ensures that the validation checks are both unpredictable and tightly integrated with the content of the file, requiring genuine review and engagement from the reviewers.

At block 306, the reviewer may check the file, encounter a validation check (e.g., 318, 320), and provide a response to the validation check. When the reviewer provides an answer or response to the validation check, as shown in validation responses 322 and 324, the application overseeing the review process can easily locate and extract the response based on the identity tags. The application may then compare the reviewer's provided response against the known correct response to determine whether the reviewer provided the correct response (block 308). If the reviewer provided the correct response to each validation check (“Yes” branch of block 308), then the application may determine that the file is ready for release and may remove the completed validation checks and their associated responses from the file 310. The application may also release the file upon removing all validation checks and responses from the file (block 312).

However, if the reviewer has either incorrectly responded to a validation check or has not answered all validation checks embedded within the file (“No” branch of block 308), the application may determine that at least one validation check within the file is either unanswered or has been answered incorrectly (block 314). As a result, the application may prevent the release of the file (block 316), and may provide the reviewer with a notification or alert indicating that at least one validation check within the file is either unanswered or has been answered incorrectly. For example, the reviewer may incorrectly answer a validation check by inputting the incorrect value as a solution to an arithmetic equation, and the application may flag the validation check as incorrectly answered and may alert the reviewer to the incorrect response and the location of the validation check. As another example, the reviewer may simply fail to see or otherwise overlook a validation check present within the file and may attempt to release the file without responding to the validation check. The application may identify the unanswered validation check, and prior to releasing the file, may alert the reviewer to the unanswered validation check and prevent the file's release.

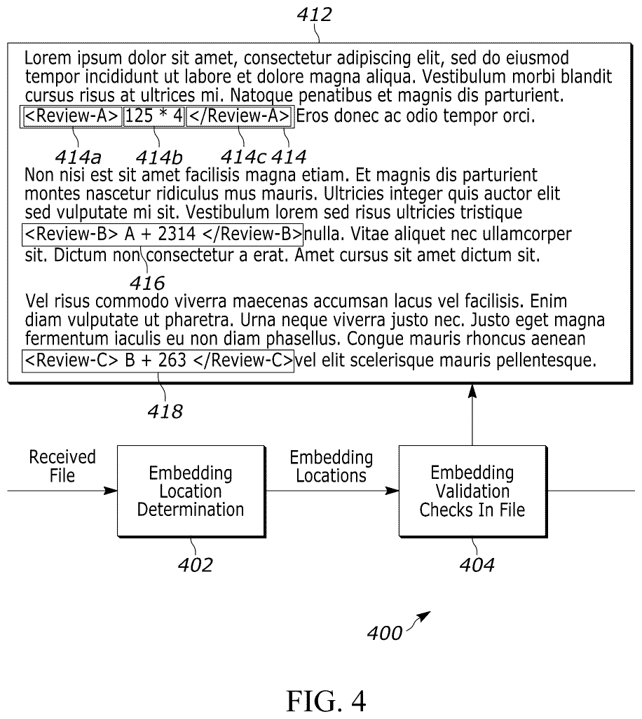

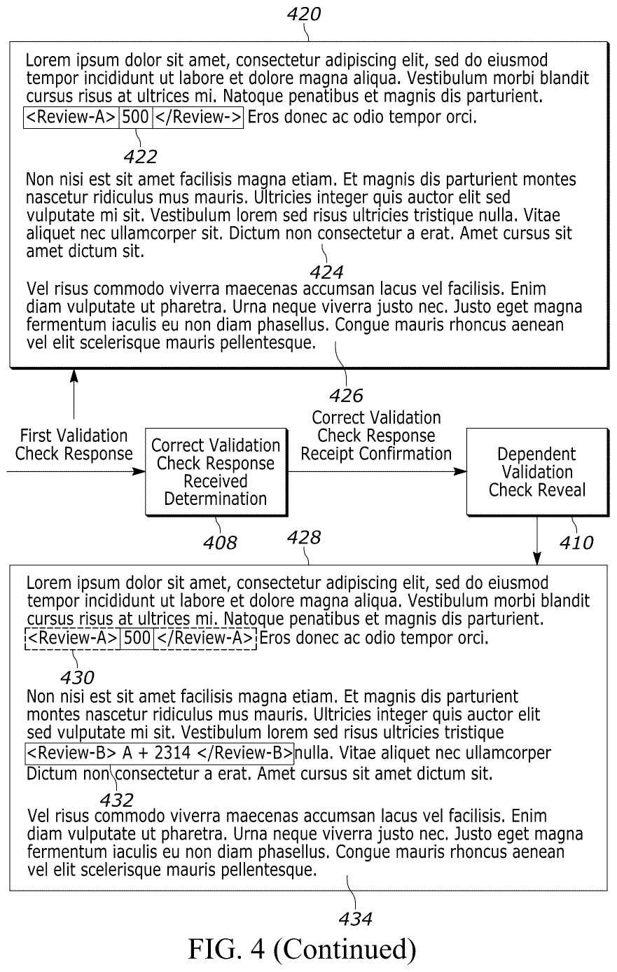

FIG. 4 depicts an example validation check embedding and dependent reveal computer-implemented process 400, in accordance with various embodiments described herein. The example validation check embedding and dependent reveal computer-implemented process 400 indicates how the components described herein (e.g., validation application 102d, validation algorithm 102e) may embed validation checks in a file and selectively reveal validation checks upon receipt of correct responses to prior validation checks. In this manner, the process 400 highlights how the present techniques enhance the effectiveness of the proof of review process by limiting the number of validation checks visible/accessible by the reviewer at any time during file review, and thereby preventing the reviewer from immediately viewing and answering validation checks without engaging with the file data.

The process 400 may include receiving a file and determining the embedding locations for the validation checks, such as through a randomization algorithm (e.g., algorithm 102f). The process 400 may further includes embedding the validation checks in the file at the determined embedding locations (block 404). Embedded validation checks within a file are generally represented at block 412, where a first validation check 414, a second validation check 416, and a third validation check 418 are embedded within the data of the file. Each validation check 414, 416, and 418 each include a set of identity tags that delineate the location of the question included as part of the validation checks 414, 416, and 418. For example, the first validation check 414 includes a set of identity tags 414a and 414c (e.g., “<Review-A>” and “</Review-A>”) that delineate the location of the question 414b (e.g., “125*4”) included as part of the first validation check 414.

The correct responses to the second validation check 416 and the third validation check 418 may be dependent on the correct response to the first validation check 414 and the second validation check 416, respectively. Namely, the correct response to the second validation check 416 is based on the correct response to the first validation check 442 (e.g., “A+2314”, where A is the answer to Review A) and the correct response to the third validation check 418 is based on the correct response to the second validation check 416 (e.g., “B+263”, where B is the answer to Review B). In this manner, these validation checks are dependent on one another, which ensures that reviewers engage with the content sequentially. More specifically, the second validation check 416 may be dependent on the first validation check 414 because the correct response to the second validation check 416 may be dependent on the correct response to the first validation check 414, and the third validation check 418 may be dependent on the second validation check 416 because the correct response to the third validation check 418 may be dependent on the correct response to the second validation check 416.

Moreover, these dependencies may extend to the adjustments/transitions of validation checks between hidden states and visible states. For example, the second validation check 416 may be maintained in a hidden state (e.g., not visible to the reviewer) until the correct response to the first validation check 414 is received, such that the status of the second validation check 416 as either visible or hidden may be dependent on whether a correct response to the first validation check 414 has been received. Similarly, the third validation check 418 may be maintained in the hidden state until the correct response to the second validation check 416 is received, such that the status of the third validation check 418 as either visible or hidden may be dependent on whether a correct response to the second validation check 416 has been received. Once the correct response to the first validation check 414 is received, the second validation check 416 may be revealed (e.g., revealed into a visible state) within the file contents, and once the correct response to the second validation check 416 is received, the third validation check 418 may be revealed (e.g., revealed into a visible state) within the file contents.

This sequential engagement can improve the review of files where understanding the material in a specific order is necessary for a comprehensive review, and it prevents reviewers from skipping ahead or randomly guessing answers without thoroughly engaging with the preceding content. Further, as reviewers must understand and correctly respond to one validation check before moving to the next, they are more likely to pay closer attention to the content, leading to a deeper understanding of the material.

Additionally, this dependent chain of validation checks (e.g., validation checks 414, 416, and 418) ensures that reviewers cannot circumvent or otherwise impermissibly bypass the proof of review process. Reviewers cannot simply use external resources to find answers or guess without engaging with the content, as each response in the sequence builds on the last, thereby enhancing the integrity of the review process. Moreover, the dependency between validation checks adds an additional layer of protection against automated bots or scripts attempting to complete the review process without genuine engagement. The complexity of having to correctly answer dependent questions in sequence increases the challenge for automated systems to predict or brute-force the correct responses.

When embedded, the application may cause up to all but one of the validation checks (e.g., the first validation check 414) to be invisible and/or otherwise inaccessible to the reviewer (e.g., in a hidden state) when the reviewer initiates their review of the file, such that the first validation check 414 may be the only validation check initially in a visible state within the file. As illustrated in block 420, the reviewer may reach the first validation check 422 (e.g., in a visible state) and may provide a response (“500”) to the first validation check 422. While illustrated in FIG. 4 as displaying the set of identity tags (e.g., “<Review-A>” and “</Review-A>”), it should be appreciated that the applications executing the process 400 may hide these identity tags within the file data, such that only the question (e.g., “125*4”) and the reviewer's subsequent response (e.g., “500”) is visible within the file data. Further, each of the second validation check 416 and the third validation check 418 are in a hidden state (e.g., not visible) within the file data, as illustrated by the blank spaces 424 and 426 in block 420. Of course, these blank spaces 424 and 426 are for the purposes of illustration and discussion only, and the original text of the file may not be adjusted (e.g., with blank spaces 424, 426) based on the embedding of a validation check until the validation check is visible and/or otherwise accessible by the reviewer as part of the dependent chain of validation checks.

At block 408, the process 400 may further include determining whether the first validation check response provided by the reviewer is correct. If the application executing the process 400 determines that the first validation check response is correct, the process 400 may further include revealing the second validation check 416 within the file, such that the second validation check 416 is revealed into a visible state (block 410). Block 428 illustrates the dependent validation check reveal performed at block 410, wherein the second validation check 432 is revealed into a visible state within the text of the file in response to the application determining that the reviewer's provided response (e.g., “500”) to the first validation check 430 is correct. Thus, when the reviewer analyzes the subsequent paragraph containing the second validation check 432, the reviewer may view the second validation check 432 and determine a response to the second validation check 432. The correct response to the second validation check 432 (e.g., “A+2314”) may be based on the correct response to the first validation check 430 (e.g., “500”), where the “A” in the second validation check 432 represents the correct response to the first validation check 430.

As illustrated in block 428, the third validation check 418 may still be invisible (e.g., in a hidden state) within the file contents (e.g., represented by blank space 434), despite the second validation check 432 being revealed (e.g., in the visible state), as the reviewer must provide the correct response to the second validation check 432 before the third validation check 418 is revealed. Moreover, in certain embodiments, the application may remove a portion or up to all of the first validation check 430 may be removed from the file contents after the application determines that the reviewer has provided the correct response. For example, the application may leave the correct response (e.g., “500”) in the file after validating the response, but may make the set of identity tags (e.g., “<Review-A>” and “</Review-A>”) invisible/hidden within the file to reduce visual clutter while enabling the reviewer to reference the prior correct answer to more readily answer the second validation check 432 that depends on the first correct response.

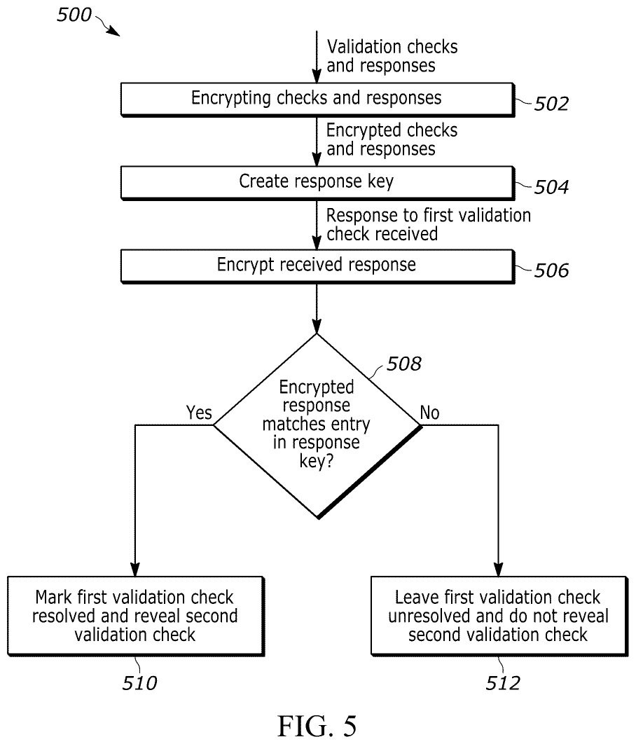

FIG. 5 depicts an example validation check encryption computer-implemented process 500, in accordance with various embodiments described herein. The process 500 generally comprises one or more of the components described herein (e.g., validation application 102d, validation algorithm 102e, encryption algorithm 102g) encrypting validation checks and/or their associated responses, creating a response key comprising such encrypted checks/responses, and validating reviewer submitted responses against the response key.

At block 502, the process 500 includes receiving validation checks and associated responses, which may be determined by the applications/algorithms described herein, and encrypting the received validation checks and/or the associated responses. The components described herein may utilize any suitable encryption techniques to encrypt the validation checks, the associated responses, and/or any data within the file. For example, the encryption algorithm described herein may utilize symmetric encryption to encrypt the content of the file, validation checks, and associated responses, as symmetric encryption is fast and efficient, generally making it suitable for encrypting large files or datasets. As another example, the encryption algorithm may utilize asymmetric (public-key) encryption to encrypt the responses to validation checks, ensuring that only the entity with the corresponding private key (e.g., the validation application) can decrypt and verify the responses. As yet another example, the encryption algorithm may utilize homomorphic encryption to perform certain validation checks on encrypted responses without revealing the content of the responses themselves, thereby preventing the use of LLMs or databases to find matching answers.

At block 504, the process 500 includes creating a response key using the encrypted checks, responses, and/or portions of the file data. Creating the response key may generally comprise storing the identity tags or unique identifiers (or encrypted versions of such) of the validation checks and the encrypted associated response within a particular location in memory that is designated for the response key. The encrypted validation checks and their encrypted associated responses being associated with their respective unique identifiers forms the basis of the response key, where each entry in the response key may specifically consist of a unique identifier linked to the encrypted validation check and its encrypted associated response.

With the response key, the validation application may receive a response to a validation check (e.g., a first validation check) from a reviewer and encrypt the received response (block 506). The application may then compare this encrypted received response with entries in the response key to determine whether the encrypted received response matches any of the encrypted associated responses in the response key (block 508). If the application determines that the encrypted response matches the corresponding entry in the response key (“Yes” branch of block 508) the application may mark the first validation check as resolved and may reveal a second validation check, which has an associated response that is dependent on the associated response to the first validation check (block 510). However, if the application determines that the encrypted response does not match the corresponding entry in the response key (“No” branch of block 508) the application may leave the first validation check as unresolved and may not reveal the second validation check (block 512). The application may also generate an alert to the reviewer indicating that the submitted response was incorrect and that the reviewer must re-submit a response to the first validation check in order to proceed with the proof of review process.

As an example, suppose the validation application determines a validation check that asks, “What is the sum of 8 and 5?,” such that the correct response to this validation check is “13”. The application may use symmetric encryption to encrypt both the validation check and the associated correct response. Namely, the encryption algorithm may transform “What is the sum of 8 and 5?” into “A1B2C3” and the correct response “13” into “D4E5F6”. The application may assign a unique identifier to this validation check, for example, “VC001”, which it then stores along with the encrypted validation check “A1B2C3” and its encrypted associated response “D4E5F6” in the response key. A reviewer may submit their response to the validation check, correctly calculating the sum as “13”. The application may receive this response and encrypt it using the same symmetric encryption, resulting in “D4E5F6” since the encryption process is deterministic and the input “13” is the same as the correct response. The application may retrieve the encrypted associated response “D4E5F6” for the validation check identified by “VC001” from the response key and may compare this encrypted associated response (“D4E5F6”) with the encrypted submitted response. The application may determine that the reviewer has provided the correct response to the validation check because the encrypted submitted response matches the encrypted associated response in the response key, and the application may mark the validation check as resolved and reveal the next validation check to the reviewer, allowing them to continue with the review process.

In certain embodiments, block 504 may comprise creating a response key that is representative of an encrypted version of a final/last response to a final/last validation check present in a file. For example, a file may include three validation checks, the third validation check may have a response that is dependent on the correct response to the second validation check (which is itself dependent on the correct response to the first validation check) and the response key may comprise or include an encrypted version of the correct response to the third validation check. The encryption of the third correct response may be based on the encryption of the second correct response, and by extension, the first correct response(e.g., as a result of their dependence). Thus, when a reviewer submits a response to the third validation check, the method 500 may include encrypting only this final (third) response (e.g., and not the first/second submitted responses) and determining whether this response matches the entry in the response key. If so, then the method 500 may mark the final validation check as resolved and may release the file.

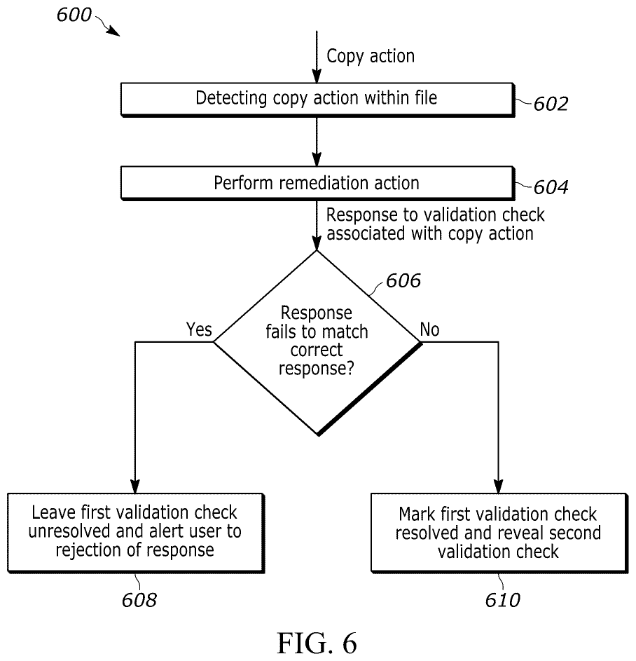

FIG. 6 depicts an example validation check circumvention prevention computer-implemented process 600, in accordance with various embodiments described herein. The process 600 generally comprises one or more of the components described herein (e.g., validation application 102d, validation algorithm 102e) analyzing actions performed by a reviewer within a file to detect any actions that are potentially impermissible as part of the proof of review process (e.g., impermissible copy actions, modifying the file to remove validation checks) and taking actions to prevent such actions negatively impacting the proof of review process.

At block 602, the process 600 includes detecting a copy action within a file that is performed by a reviewer. These copy actions may be or include a copy command performed by the reviewer related to portions of the data in the file (e.g., text, validation checks), and may also include other actions such as opening another browser tab, attempting to print or screenshot the file through the review interface, navigating away from the review interface (e.g., monitoring focus events), rapid or unusual response patterns (e.g., indicating potential use of automated tools or scripts), text extraction attempts (e.g., monitoring for unusual API calls or interactions with the document that are indicative of extraction attempts), inputting responses without viewing content (e.g., tracking scrolling, highlighting, or time spent on pages), multiple rapid page navigations (e.g., monitoring the speed and pattern of page changes), and/or any other actions or combinations thereof. Thus, while referenced herein as “copy actions”, it should be appreciated that these copy actions may be or include other actions that do not necessarily involve copying data.

For example, the validation application may detect a copy action within a validation check embedded in a file for proof of review purposes by monitoring the reviewer's interactions with the file's content, specifically looking for events that indicate text selection and copying. The application could utilize, e.g., event listeners or monitoring functions within the application that track specific user actions, such as highlighting text and invoking a copy command (e.g., through keyboard shortcuts like Ctrl+C or right-click context menus). Upon detecting such an action, the application may then execute one or more predefined “poison pill” remediation actions to ensure the integrity of the review process (block 604). These remediation actions may include the application inserting a character into the copied text, the response, the validation check, and/or the file data to prevent a submitted response from the reviewer matching the associated response for the validation check.

For example, consider a scenario where a reviewer encounters an arithmetic validation check within the file asking, “What is the product of 7 and 6?” Instead of calculating the answer themselves, the reviewer decides to copy the question with the intention of pasting it into an external calculator or search engine. The validation application, equipped to monitor and detect such copy actions within the vicinity of validation checks, identifies this event. Upon detecting the copy action, the validation application may intervene by automatically modifying the copied question in a subtle yet significant way. As an example, if the original question is “What is the product of 7 and 6?”, the validation application may alter the copied text to “What is the product of 7 and 16?” or change the operation, resulting in “What is the sum of 7 and 6?” The reviewer, unaware of the alteration, may paste the modified question into an external calculator or search engine and obtain an incorrect response (e.g., “112” for the product of 7 and 16, or “13” for the sum of 7 and 6). When the reviewer submits this incorrect response into the response field for the validation check, the validation application may determine that it does not match the correct answer (“42”) that the application expects for the original question. This discrepancy signals to the application that the review process may have been compromised, indicating that the reviewer attempted to circumvent the intended engagement with the content by relying on external assistance rather than calculating the answer themselves.

As another example, consider a scenario where a reviewer is presented with an arithmetic validation check in the file, asking, “ What is the square root of 49?” Instead of attempting to solve the question within the review interface, the reviewer may navigate away from the review interface to use an external calculator or search engine for the answer. The validation application, designed to monitor and detect such focus shifts away from the review interface (e.g., detecting when the reviewer clicks outside the review interface or switches tabs or windows), may identify this event and may implement a remediation action configured to encourage direct engagement and problem-solving within the review interface. The application may temporarily lock the review interface and display a message or a hint directly related to the validation check without directly providing the answer. For example, the message might say, “Remember, the square root of a number is a value that, when multiplied by itself, gives the original number. Try solving it here!” The reviewer, upon returning to the review interface and seeing the hint, may be encouraged to solve the problem directly without external assistance. However, the application may also set a time limit for the reviewer to return to the review interface and provide the correct response before the question included as part of the validation check changes. For example, if the reviewer does not return to the review interface within ten seconds to attempt the calculation without external assistance, the validation application may change the question to “What is the square root of 144?”, such that even if the reviewer used an external calculator to get the correct response to the original question (7), this response would no longer be considered correct.

This remediation action approach serves multiple purposes. It discourages reviewers from attempting to circumvent the review process through simple copy-paste actions or other similar actions and maintains the integrity of the proof of review process by ensuring that reviewers engage with the content, and it provides a mechanism for detecting and mitigating attempts to bypass validation checks. This technique thereby enhances the security and effectiveness of the proof of review process, ensuring that the validation checks fulfill their intended role in verifying genuine engagement and review of the file's data/content.

When the reviewer submits a response that may be associated with a copy action, the validation application may determine whether the received response matches the associated response for the validation check (block 606). If the validation application determines that the received response fails to match the associated response (“Yes” branch of block 606), the application may leave the validation check as unresolved and may alert the user to the rejection of the response (block 608). However, if the validation application determines that the received response matches the associated response (“No” branch of block 606), the application may mark the validation check as resolved and may reveal a subsequent validation check (e.g., block 610).

### Example Computer-Implemented Methods

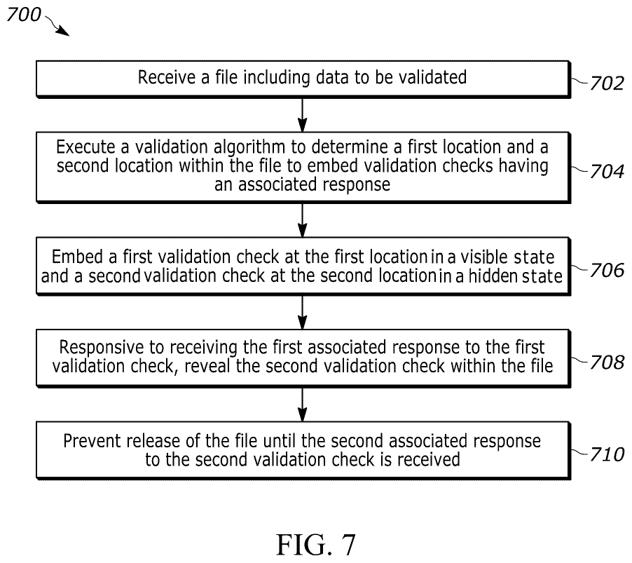

FIG. 7 depicts a flow diagram representing an example computer-implemented method 700, in accordance with various embodiments described herein. The method 700 may be implemented by one or more processors of the example computing system 100, such as the processor 102a of central server 102 (e.g., by validation application 102d), for example.

The method 700 may include receiving a file including data to be validated (block 702). The method 700 may further include executing a validation algorithm that causes one or more processors to perform operations comprising determining a first location and a second location within the file to embed validation checks having an associated response (block 704). The method 700 may further include executing the validation algorithm to embed a first validation check at the first location in a visible state and a second validation check at the second location in a hidden state (block 706). The second validation check may have a second associated response that is dependent on a first associated response to the first validation check.

The method 700 may further include, responsive to receiving the first associated response to the first validation check, revealing the second validation check within the file (block 708). The method 700 may further include preventing release of the file until the second associated response to the second validation check is received (block 710).

In certain embodiments, the method 700 may further include preventing, by the one or more processors, release of the file if at least one of: (i) the second associated response to the second validation check is not received, or (ii) the second validation check is removed from the file without receiving the second associated response; and upon preventing release of the file based on either (i) or (ii), generating, by the one or more processors, an output indicating the second location within the file requiring additional review prior to releasing the file.

In certain embodiments, the method 700 may further include determining, by the one or more processors, that the first associated response has been received for the first validation check and that the second associated response has been received for the second validation check; and removing, by the one or more processors, the first validation check and the second validation check from the file prior to releasing the file.

In certain embodiments, the method 700 may further include assigning, by the one or more processors, (i) a first unique identifier to a first set of tags delineating where the first validation check is embedded at the first location within the file and (ii) a second unique identifier to a second set of tags delineating where the second validation check is embedded at the second location within the file; storing, by the one or more processors, the first unique identifier in a first location associated with the first associated response and the second unique identifier in a second location associated with the second associated response; determining, by the one or more processors, that a received response to the second validation check matches the first associated response stored in association with the first unique identifier; rejecting, by the one or more processors, the received response to the second validation check; and maintaining, by the one or more processors, the second validation check within the file at the second location until the second associated response is received.

In certain embodiments, the method 700 may further include encrypting, by the one or more processors using a unique encryption scheme, (i) the first associated response and (ii) the second associated response, wherein the encryption of the second associated response is based on the encryption of the first associated response; storing, by the one or more processors, a response key comprising the encrypted first associated response and the encrypted second associated response and (ii) an indication of the chain of dependent, encrypted validation checks; encrypting, by the one or more processors, a received response associated with the first validation check; determining, by the one or more processors, whether the encrypted received response matches the encrypted first associated response in the response key; and responsive to determining that the encrypted received response matches the encrypted first associated response in the response key, revealing the second validation check within the file.

In certain embodiments, encrypting the first associated response and the second associated response based on the encrypted first associated response creates a chain of dependent, encrypted validation checks, and the method 700 may further include storing, by the one or more processors, an indication of the chain of dependent, encrypted validation checks as part of the response key; and preventing, by the one or more processors, release of the file until (i) encrypted received responses corresponding to the encrypted first associated response and the encrypted second associated response are received and (ii) the encrypted received responses are received in a sequence represented by the indication of the chain of dependent, encrypted validation checks stored in the response key.

In certain embodiments, the method 700 may further include detecting, by the one or more processors, that a copy action has occurred in association with the first validation check on a user device; and automatically inserting, by the one or more processors, a character into (i) copied text from the first validation check, (ii) a response to the first validation check, or (iii) a portion of the file outside of the first location to prevent an encrypted version of the response from matching the encrypted first associated response in the response key.

In certain embodiments, the method 700 may further include determining, by the one or more processors using a first random or pseudo-random algorithm, the first location and the second location within the file for embedding the first validation check and the second validation check; and determining, by the one or more processors using a second random or pseudo-random algorithm, (i) a first unique identifier to a first set of tags delineating where the first validation check is embedded at the first location within the file and (ii) a second unique identifier to a second set of tags delineating where the second validation check is embedded at the second location within the file.

Of course, it is to be appreciated that the actions of the method 700 may be performed any suitable number of times, and that the actions described in reference to the method 700 may be performed in any suitable order.

### EXAMPLES

Example 1. A computer-implemented method comprising: receiving, by one or more processors, a file including data to be validated; executing, by the one or more processors, a validation algorithm that causes the one or more processors to perform operations comprising: determining a first location within the file to embed a first validation check associated with a first valid response and a second location within the file to embed a second validation check associated with a second valid response that is dependent on the first valid response, embedding the first validation check at the first location in a visible state and the second validation check at the second location in a hidden state, and responsive to receiving the first valid response to the first validation check, revealing the second validation check; and preventing, by the one or more processors, release of the file until the second valid response to the second validation check is received.

Example 2. The computer-implemented method of example 1, further comprising: determining at least one of: (i) the second valid response to the second validation check is not received, or (ii) the second validation check is removed from the file without receiving the second valid response; and based on determining at least one of (i) or (ii), generating, by the one or more processors, an output indicating the second location within the file requires additional review prior to releasing the file.

Example 3. The computer-implemented method of example 1 or 2, further comprising: determining, by the one or more processors, that the first valid response has been received for the first validation check and that the second valid response has been received for the second validation check; and removing, by the one or more processors, the first validation check and the second validation check from the file prior to releasing the file.

Example 4. The computer-implemented method of any of examples 1 through 3, further comprising: assigning, by the one or more processors, (i) a first unique identifier to a first set of tags delineating where the first validation check is embedded at the first location within the file and (ii) a second unique identifier to a second set of tags delineating where the second validation check is embedded at the second location within the file; storing, by the one or more processors, the first unique identifier in a first location associated with the first valid response and the second unique identifier in a second location associated with the second valid response; determining, by the one or more processors, that a received response to the second validation check matches the first valid response stored in association with the first unique identifier; rejecting, by the one or more processors, the received response to the second validation check; and maintaining, by the one or more processors, the second validation check within the file at the second location until the second valid response is received.

Example 5. The computer-implemented method of any of examples 1 through 4, further comprising: encrypting, by the one or more processors using a unique encryption scheme, (i) the first valid response and (ii) the second valid response, wherein encrypting the first valid response and the second valid response creates a chain of dependent, encrypted validation checks; storing, by the one or more processors, a response key comprising the encrypted first valid response, the encrypted second valid response, and an indication of the chain of dependent, encrypted validation checks; encrypting, by the one or more processors, a received response associated with the first validation check; determining, by the one or more processors, whether the encrypted received response matches the encrypted first valid response in the response key; responsive to determining that the encrypted received response matches the encrypted first valid response in the response key, revealing the second validation check within the file; and preventing, by the one or more processors, release of the file until (i) encrypted received responses corresponding to the encrypted first valid response and the encrypted second valid response are received and (ii) the encrypted received responses are received in a sequence represented by the indication of the chain of dependent, encrypted validation checks stored in the response key.

Example 6. The computer-implemented method of any of examples 1 through 5, wherein the computer-implemented method further comprises: encrypting, by the one or more processors using a unique encryption scheme, (i) the first valid response and (ii) the second valid response, wherein the encryption of the second valid response is based on the encryption of the first valid response; storing, by the one or more processors, a response key comprising the encrypted second valid response; encrypting, by the one or more processors, a received response associated with the second validation check; determining, by the one or more processors, whether the encrypted received response matches the encrypted second valid response in the response key; and responsive to determining that the encrypted received response matches the encrypted second valid response, releasing, by the one or more processors, the file.

Example 7. The computer-implemented method of any of examples 1 through 6, further comprising: detecting, by the one or more processors, that a copy action has occurred in association with the first validation check on a user device; and automatically inserting, by the one or more processors, a character into (i) copied text from the first validation check, (ii) a response to the first validation check, or (iii) a portion of the file outside of the first location.

Example 8. The computer-implemented method of any of examples 1 through 7, further comprising: determining, by the one or more processors using a first random or pseudo-random algorithm, the first location and the second location within the file for embedding the first validation check and the second validation check; and determining, by the one or more processors using a second random or pseudo-random algorithm, (i) a first unique identifier to a first set of tags delineating where the first validation check is embedded at the first location within the file and (ii) a second unique identifier to a second set of tags delineating where the second validation check is embedded at the second location within the file.

Example 9. A system comprising: one or more processors; and at least one memory storing processor-executable instructions that, when executed by the one or more processors, cause the one or more processors to perform operations comprising: determining a first location within a file to embed a first validation check with a first associated response and a second location within the file to embed a second validation check associated with a second associated response that is dependent on the first associated response; embedding the first validation check at the first location in a visible state and the second validation check at the second location in a hidden state; responsive to receiving the first associated response to the first validation check, revealing the second validation check; and preventing release of the file until the second associated response to the second validation check is received.

Example 10. The system of example 9, wherein the processor-executable instructions, when executed by the one or more processors, further cause the one or more processors to perform operations comprising: determining at least one of: (i) the second associated response to the second validation check is not received, or (ii) the second validation check is removed from the file without receiving the second associated response; and based on determining at least one of (i) or (ii), generating an output indicating the second location within the file requires additional review prior to releasing the file.

Example 11. The system of example 9 or 10, wherein the processor-executable instructions, when executed by the one or more processors, further cause the one or more processors to perform operations comprising: determining that the first associated response has been received for the first validation check and that the second associated response has been received for the second validation check; and removing the first validation check and the second validation check from the file prior to releasing the file.

Example 12. The system of any of examples 9 through 11, wherein the processor-executable instructions, when executed by the one or more processors, further cause the one or more processors to perform operations comprising: assigning (i) a first unique identifier to a first set of tags delineating where the first validation check is embedded at the first location within the file and (ii) a second unique identifier to a second set of tags delineating where the second validation check is embedded at the second location within the file; storing the first unique identifier in a first location associated with the first associated response and the second unique identifier in a second location associated with the second associated response; determining that a received response to the second validation check matches the first associated response stored in association with the first unique identifier; rejecting the received response to the second validation check; and maintaining the second validation check within the file at the second location until the second associated response is received.

Example 13. The system of any of examples 9 through 12, wherein the processor-executable instructions, when executed by the one or more processors, further cause the one or more processors to perform operations comprising: encrypting, using a unique encryption scheme, (i) the first associated response and (ii) the second associated response, wherein encrypting the first associated response and the second associated response creates a chain of dependent, encrypted validation checks; storing a response key comprising the encrypted first associated response, the encrypted second associated response, and an indication of the chain of dependent, encrypted validation checks; encrypting a received response associated with the first validation check; determining whether the encrypted received response matches the encrypted first associated response in the response key; responsive to determining that the encrypted received response matches the encrypted first associated response in the response key, revealing the second validation check within the file; and preventing release of the file until (i) encrypted received responses corresponding to the encrypted first associated response and the encrypted second associated response are received and (ii) the encrypted received responses are received in a sequence represented by the indication of the chain of dependent, encrypted validation checks stored in the response key.

Example 14. The system of any of examples 9 through 13, wherein the processor-executable instructions, when executed by the one or more processors, further cause the one or more processors to perform operations comprising: encrypting, using a unique encryption scheme, (i) the first associated response and (ii) the second associated response, wherein the encryption of the second associated response is based on the encryption of the first associated response; storing a response key comprising the encrypted second associated response; encrypting a received response associated with the second validation check; determining whether the encrypted received response matches the encrypted second associated response in the response key; and responsive to determining that the encrypted received response matches the encrypted second associated response in the response key, releasing the file.

Example 15. The system of any of examples 9 through 14, wherein the processor-executable instructions, when executed by the one or more processors, further cause the one or more processors to perform operations comprising: detecting that a copy action has occurred in association with the first validation check on a user device; and automatically inserting a character into (i) copied text from the first validation check, (ii) a response to the first validation check, or (iii) a portion of the file outside of the first location.

Example 16. The system of any of examples 9 through 15, wherein the processor-executable instructions, when executed by the one or more processors, further cause the one or more processors to perform operations comprising: determining, using a first random or pseudo-random algorithm, the first location and the second location within the file for embedding the first validation check and the second validation check; and determining, using a second random or pseudo-random algorithm, (i) a first unique identifier to a first set of tags delineating where the first validation check is embedded at the first location within the file and (ii) a second unique identifier to a second set of tags delineating where the second validation check is embedded at the second location within the file.

Example 17. One or more non-transitory computer-readable media storing processor-executable instructions that, when executed by one or more processors, cause the one or more processors to perform operations comprising: determining a first location within a file to embed a first validation check with a first associated response and a second location within the file to embed a second validation check with a second associated response that is dependent on the first associated response; embedding the first validation check at the first location in a visible state and the second validation check at the second location in a hidden state; responsive to receiving the first associated response to the first validation check, revealing the second validation check; and preventing release of the file until the second associated response to the second validation check is received.

Example 18. The one or more non-transitory computer-readable media of example 17, wherein the processor-executable instructions, when executed by the one or more processors, further cause the one or more processors to perform operations comprising: determining at least one of: (i) the second associated response to the second validation check is not received, or (ii) the second validation check is removed from the file without receiving the second associated response; and based on determining at least one of (i) or (ii), generating, by the one or more processors, an output indicating the second location within the file requires additional review prior to releasing the file.

Example 19. The one or more non-transitory computer-readable media of example 17 or 18, wherein the processor-executable instructions, when executed by the one or more processors, further cause the one or more processors to perform operations comprising: determining that the first associated response has been received for the first validation check and that the second associated response has been received for the second validation check; and removing the first validation check and the second validation check from the file prior to releasing the file.

Example 20. The one or more non-transitory computer-readable media of any of examples 17 through 19, wherein the processor-executable instructions, when executed by the one or more processors, further cause the one or more processors to perform operations comprising: assigning (i) a first unique identifier to a first set of tags delineating where the first validation check is embedded at the first location within the file and (ii) a second unique identifier to a second set of tags delineating where the second validation check is embedded at the second location within the file; storing the first unique identifier in a first location associated with the first associated response and the second unique identifier in a second location associated with the second associated response; determining that a received response to the second validation check matches the first associated response stored in association with the first unique identifier; rejecting the received response to the second validation check; and maintaining the second validation check within the file at the second location until the second associated response is received.

### Additional Considerations

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine-learned model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
receiving, by one or more processors, a file including data to be validated;
executing, by the one or more processors, a validation algorithm that causes the one or more processors to perform operations comprising:
determining a first location within the file to embed a first validation check associated with a first valid response and a second location within the file to embed a second validation check associated with a second valid response that is dependent on the first valid response,
embedding the first validation check at the first location in a visible state and the second validation check at the second location in a hidden state, and
responsive to receiving the first valid response to the first validation check, revealing the second validation check; and
preventing, by the one or more processors, release of the file until the second valid response to the second validation check is received.

2. The computer-implemented method of claim 1, further comprising:
determining at least one of: (i) the second valid response to the second validation check is not received, or (ii) the second validation check is removed from the file without receiving the second valid response; and
based on determining at least one of (i) or (ii), generating, by the one or more processors, an output indicating the second location within the file requires additional review prior to releasing the file.

3. The computer-implemented method of claim 1, further comprising:
determining, by the one or more processors, that the first valid response has been received for the first validation check and that the second valid response has been received for the second validation check; and
removing, by the one or more processors, the first validation check and the second validation check from the file prior to releasing the file.

4. The computer-implemented method of claim 1, further comprising:
assigning, by the one or more processors, (i) a first unique identifier to a first set of tags delineating where the first validation check is embedded at the first location within the file and (ii) a second unique identifier to a second set of tags delineating where the second validation check is embedded at the second location within the file;
storing, by the one or more processors, the first unique identifier in a first location associated with the first valid response and the second unique identifier in a second location associated with the second valid response;
determining, by the one or more processors, that a received response to the second validation check matches the first valid response stored in association with the first unique identifier;
rejecting, by the one or more processors, the received response to the second validation check; and
maintaining, by the one or more processors, the second validation check within the file at the second location until the second valid response is received.

5. The computer-implemented method of claim 1, further comprising:
encrypting, by the one or more processors using a unique encryption scheme, (i) the first valid response and (ii) the second valid response, wherein encrypting the first valid response and the second valid response creates a chain of dependent, encrypted validation checks;
storing, by the one or more processors, a response key comprising the encrypted first valid response, the encrypted second valid response, and an indication of the chain of dependent, encrypted validation checks;
encrypting, by the one or more processors, a received response associated with the first validation check;
determining, by the one or more processors, whether the encrypted received response matches the encrypted first valid response in the response key;
responsive to determining that the encrypted received response matches the encrypted first valid response in the response key, revealing the second validation check within the file; and
preventing, by the one or more processors, release of the file until (i) encrypted received responses corresponding to the encrypted first valid response and the encrypted second valid response are received and (ii) the encrypted received responses are received in a sequence represented by the indication of the chain of dependent, encrypted validation checks stored in the response key.

6. The computer-implemented method of claim 1, wherein the computer-implemented method further comprises:
encrypting, by the one or more processors using a unique encryption scheme, (i) the first valid response and (ii) the second valid response, wherein the encryption of the second valid response is based on the encryption of the first valid response;
storing, by the one or more processors, a response key comprising the encrypted second valid response;
encrypting, by the one or more processors, a received response associated with the second validation check;
determining, by the one or more processors, whether the encrypted received response matches the encrypted second valid response in the response key; and
responsive to determining that the encrypted received response matches the encrypted second valid response, releasing, by the one or more processors, the file.

7. The computer-implemented method of claim 1, further comprising:
detecting, by the one or more processors, that a copy action has occurred in association with the first validation check on a user device; and
automatically inserting, by the one or more processors, a character into (i) copied text from the first validation check, (ii) a response to the first validation check, or (iii) a portion of the file outside of the first location.

8. The computer-implemented method of claim 1, further comprising:
determining, by the one or more processors using a first random or pseudo-random algorithm, the first location and the second location within the file for embedding the first validation check and the second validation check; and
determining, by the one or more processors using a second random or pseudo-random algorithm, (i) a first unique identifier to a first set of tags delineating where the first validation check is embedded at the first location within the file and (ii) a second unique identifier to a second set of tags delineating where the second validation check is embedded at the second location within the file.

9. A system comprising:
one or more processors; and
at least one memory storing processor-executable instructions that, when executed by the one or more processors, cause the one or more processors to perform operations comprising:
determining a first location within a file to embed a first validation check with a first associated response and a second location within the file to embed a second validation check associated with a second associated response that is dependent on the first associated response;
embedding the first validation check at the first location in a visible state and the second validation check at the second location in a hidden state;
responsive to receiving the first associated response to the first validation check, revealing the second validation check; and
preventing release of the file until the second associated response to the second validation check is received.

10. The system of claim 9, wherein the processor-executable instructions, when executed by the one or more processors, further cause the one or more processors to perform operations comprising:
determining at least one of: (i) the second associated response to the second validation check is not received, or (ii) the second validation check is removed from the file without receiving the second associated response; and
based on determining at least one of (i) or (ii), generating an output indicating the second location within the file requires additional review prior to releasing the file.

11. The system of claim 9, wherein the processor-executable instructions, when executed by the one or more processors, further cause the one or more processors to perform operations comprising:
determining that the first associated response has been received for the first validation check and that the second associated response has been received for the second validation check; and
removing the first validation check and the second validation check from the file prior to releasing the file.

12. The system of claim 9, wherein the processor-executable instructions, when executed by the one or more processors, further cause the one or more processors to perform operations comprising:
assigning (i) a first unique identifier to a first set of tags delineating where the first validation check is embedded at the first location within the file and (ii) a second unique identifier to a second set of tags delineating where the second validation check is embedded at the second location within the file;
storing the first unique identifier in a first location associated with the first associated response and the second unique identifier in a second location associated with the second associated response;
determining that a received response to the second validation check matches the first associated response stored in association with the first unique identifier;
rejecting the received response to the second validation check; and
maintaining the second validation check within the file at the second location until the second associated response is received.

13. The system of claim 9, wherein the processor-executable instructions, when executed by the one or more processors, further cause the one or more processors to perform operations comprising:
encrypting, using a unique encryption scheme, (i) the first associated response and (ii) the second associated response, wherein encrypting the first associated response and the second associated response creates a chain of dependent, encrypted validation checks;
storing a response key comprising the encrypted first associated response, the encrypted second associated response, and an indication of the chain of dependent, encrypted validation checks;
encrypting a received response associated with the first validation check;
determining whether the encrypted received response matches the encrypted first associated response in the response key;
responsive to determining that the encrypted received response matches the encrypted first associated response in the response key, revealing the second validation check within the file; and
preventing release of the file until (i) encrypted received responses corresponding to the encrypted first associated response and the encrypted second associated response are received and (ii) the encrypted received responses are received in a sequence represented by the indication of the chain of dependent, encrypted validation checks stored in the response key.

14. The system of claim 9, wherein the processor-executable instructions, when executed by the one or more processors, further cause the one or more processors to perform operations comprising:
encrypting, using a unique encryption scheme, (i) the first associated response and (ii) the second associated response, wherein the encryption of the second associated response is based on the encryption of the first associated response;
storing a response key comprising the encrypted second associated response;
encrypting a received response associated with the second validation check;
determining whether the encrypted received response matches the encrypted second associated response in the response key; and
responsive to determining that the encrypted received response matches the encrypted second associated response in the response key, releasing the file.

15. The system of claim 9, wherein the processor-executable instructions, when executed by the one or more processors, further cause the one or more processors to perform operations comprising:
detecting that a copy action has occurred in association with the first validation check on a user device; and
automatically inserting a character into (i) copied text from the first validation check, (ii) a response to the first validation check, or (iii) a portion of the file outside of the first location.

16. The system of claim 9, wherein the processor-executable instructions, when executed by the one or more processors, further cause the one or more processors to perform operations comprising:
determining, using a first random or pseudo-random algorithm, the first location and the second location within the file for embedding the first validation check and the second validation check; and
determining, using a second random or pseudo-random algorithm, (i) a first unique identifier to a first set of tags delineating where the first validation check is embedded at the first location within the file and (ii) a second unique identifier to a second set of tags delineating where the second validation check is embedded at the second location within the file.

17. One or more non-transitory computer-readable media storing processor-executable instructions that, when executed by one or more processors, cause the one or more processors to perform operations comprising:
determining a first location within a file to embed a first validation check with a first associated response and a second location within the file to embed a second validation check with a second associated response that is dependent on the first associated response;
embedding the first validation check at the first location in a visible state and the second validation check at the second location in a hidden state;
responsive to receiving the first associated response to the first validation check, revealing the second validation check; and
preventing release of the file until the second associated response to the second validation check is received.

18. The one or more non-transitory computer-readable media of claim 17, wherein the processor-executable instructions, when executed by the one or more processors, further cause the one or more processors to perform operations comprising:
determining at least one of: (i) the second associated response to the second validation check is not received, or (ii) the second validation check is removed from the file without receiving the second associated response; and
based on determining at least one of (i) or (ii), generating, by the one or more processors, an output indicating the second location within the file requires additional review prior to releasing the file.

19. The one or more non-transitory computer-readable media of claim 17, wherein the processor-executable instructions, when executed by the one or more processors, further cause the one or more processors to perform operations comprising:
determining that the first associated response has been received for the first validation check and that the second associated response has been received for the second validation check; and
removing the first validation check and the second validation check from the file prior to releasing the file.

20. The one or more non-transitory computer-readable media of claim 17, wherein the processor-executable instructions, when executed by the one or more processors, further cause the one or more processors to perform operations comprising:
assigning (i) a first unique identifier to a first set of tags delineating where the first validation check is embedded at the first location within the file and (ii) a second unique identifier to a second set of tags delineating where the second validation check is embedded at the second location within the file;
storing the first unique identifier in a first location associated with the first associated response and the second unique identifier in a second location associated with the second associated response;
determining that a received response to the second validation check matches the first associated response stored in association with the first unique identifier;
rejecting the received response to the second validation check; and
maintaining the second validation check within the file at the second location until the second associated response is received.
